(19) United States
(12) Patent Application Publication
(10) Pub. No.: US 2011/0180032 A1
(43) Pub. Date: Jul. 28, 2011

(54) INSULATED COMBUSTION CHAMBER

(75) Inventors: Gregory S. Mungas, Mojave, CA (US); Gregory H. Peters, Palmdale, CA (US); Kenneth Doyle, Quartz Hill, CA (US); Larry R. Buchanan, La Habra, CA (US); Jose T. Banzon, JR., Glendale, CA (US)

(73) Assignee: Firestar Engineering, LLC, Mojave, CA (US)

(21) Appl. No.: 13/010,444

(22) Filed: Jan. 20, 2011

Related U.S. Application Data
(60) Provisional application No. 61/296,594, filed on Jan. 20, 2010.

(51) Int. Cl. F02F 1/24; F16J 1/00; F16J 1/01; B23P 15/10

(52) U.S. Cl. 123/193.5; 92/172; 29/888.042

(57) ABSTRACT

An insulative piston or piston cap creates a highly thermally resistive path in the axial direction of the piston or piston cap toward a crank case of an engine. An insulative cylinder is configured to be positioned around the insulative piston and adjacent an insulative cylinder head, and to provide thermal resistance in the cylinder's axial direction. The insulated cylinder head is configured to resist heat flow in the axial direction away from the crank case. High temperature insulation surrounding these structures is configured to resist heat flow out of a combustion chamber of the engine. These insulative components, together, form the fully insulated combustion chamber.

### CROSS-REFERENCE TO RELATED APPLICATIONS

The present application claims benefit of priority to U.S. Provisional Patent Application No. 61/296,594, entitled “High Operating Temperature, Fully Insulated, Regenerative Engine (HOTFIRE) Cylinder Assembly” and filed on Jan. 20, 2010, specifically incorporated by reference herein for all that it discloses or teaches.

### BACKGROUND

The fuel-air or other fuel-oxidizer combustion that occurs within the cylinders of internal combustion engines produces a significant amount of heat that is typically dissipated by the walls of the cylinders and through the piston. It is estimated that as much as fifty percent of the available mechanical power that could be generated from an internal combustion engine is lost as heat. Typically, in order to prevent damage to the engine as a result of the high temperatures generated by the exothermic fuel-oxidizer combustion reaction, cooling the walls of the cylinder with air or water is required. This engine cooling creates the mechanism for dissipating heat out of the combustion gases which reduces the amount of mechanical power that can be extracted from these gases. As a result, this dissipation of heat greatly reduces the efficiency of the engine. For example, in a car, it is estimated that approximately 25 percent of the available chemical energy from the fuel-oxidizer combustion in the engine is dissipated through the radiator. This is comparable to the percent of total available power that is converted into useful mechanical power coming out the engine crankshaft. The rest of the energy is typically lost through the exhaust system (although partial recovery may occur through incorporating turbochargers or similar mechanisms in the exhaust).

While many ceramic and other seemingly insulative coatings have been applied to piston-faces, cylinder head surfaces, and cylinder walls in attempts to minimize heat loss, the thermal resistance of such relatively thin coatings is negligible in comparison to the thicknesses of the insulation applied here. Ceramic engines have been investigated, but typically employ materials that must be at least partially cooled to survive the flame temperatures encountered in fuel-air combustion.

### SUMMARY

The presently disclosed technology increases the efficiency of internal combustion engines by providing for a low-heat rejection piston assembly. In one implementation, an insulative piston creates a highly thermally resistive path from a combustion chamber through the piston. An insulative cylinder surrounds the insulative piston and provides a highly thermally resistive path from the combustion chamber through the insulative cylinder. An insulative cylinder head covers the top of the insulative cylinder and provides a highly thermally resistive path from the combustion chamber through the insulative cylinder head. In combination, the insulative piston, the insulative cylinder, and the insulative cylinder head creates an insulated combustion chamber for an internal combustion engine.

In another implementation, an insulative piston cap is attached to the top of a conventional piston and creates a highly thermally resistive path from the combustion chamber through the insulative piston cap. An insulative upper cylinder surrounds the insulative piston, is positioned between a conventional cylinder and an insulative cylinder head, and provides a highly thermally resistive path from the combustion chamber through the insulative upper cylinder. The insulated cylinder head covers the top of the insulative cylinder and provides a highly thermally resistive path from the combustion chamber through the insulative cylinder head. In combination, the insulative piston cap, the insulative cylinder, and the insulative cylinder head creates an insulated combustion chamber for an internal combustion engine.

Insulated combustion chambers as described in detail herein operate at relatively higher temperature and/or pressures for generating useful work. As a result, unique materials a/or fabrication techniques may be used to construct various components insulating the combustion chambers so that those components tolerate the operating temperatures and/or pressures.

### BRIEF DESCRIPTIONS OF THE DRAWINGS

FIG. 1 is an example insulative piston for a reciprocating internal combustion engine.

FIG. 2 is an example insulative piston cap on a piston for a reciprocating internal combustion engine.

FIG. 3A is an example insulative piston assembly in a top-dead center orientation.

FIG. 3B is the example insulative piston assembly of FIG. 3A in a bottom-dead center orientation.

FIG. 4A is another example insulative piston assembly in a top-dead center orientation.

FIG. 4B is the example insulative piston assembly of FIG. 4A in a bottom-dead center orientation.

FIG. 5 illustrates example operations for manufacturing an insulative piston assembly for a reciprocating internal combustion engine.

### DETAILED DESCRIPTIONS

The internal combustion engine is an engine in which the combustion of a fuel (e.g., a fossil fuel) occurs with an oxidizer (e.g., air) in a combustion chamber. In an internal combustion engine the expansion of the high-temperature and high-pressure gases produced by combustion applies direct force to some component(s) of the engine, such as one or more pistons, turbine blades, or nozzles. This force moves the component(s) over a distance, generating useful mechanical energy. Typically, the combustion is intermittent, such as four-stroke and two-stroke piston engines, along with variants, such as the Wankel rotary engine. Other internal combustion engines include spark-ignition, compression-ignition, five-stroke, six-stroke, Atkinson cycle, for example. The presently disclosed technology may be applied to any internal combustion engine.

The fuel may include one or more of gasoline, diesel fuel, autogas, compressed natural gas, jet fuel, aviation fuel, fuel oil, various alcohols (e.g., ethanol, methanol, and butanol), waste peanut oil/vegetable oils, and various biofuels (e.g., biobutanol, bioenthanol, biomethanol, biodiesel, biogas), and hydrogen, for example. Further, the oxidizer may include one or more of air, oxygen, nitro-methane, nitrous-oxide, hydrogen peroxide, chlorine, and fluorine, for example. In bipropellant systems, the fuel and the oxidizer are kept separate until the point of ignition where the fuel and oxidizer are mixed together for combustion in the combustion chamber. In monopropellant systems, any one or more fuels may be pre-mixed with any one or more oxidizers. The monopropellant may then be moved to the point of ignition for combustion in the combustion chamber. The presently disclosed technology may be applied to any fuel and oxidizer combination in both bipropellant and monopropellant internal combustion engines.

Further, the presently disclosed technology may be applied to reciprocating internal combustion engines, also often known as piston engines, which use one or more reciprocating pistons to convert pressure into a rotating motion. The presently disclosed technology may also apply to some non-reciprocating internal combustion engines, such as the Wankel engine. Further, the presently disclosed technology may also apply to some non-internal combustion engines, such as the Sterling engine.

The presently disclosed technology insulates the combustion chambers of an internal combustion engine resulting in less than 5% of the heat loss a standard internal combustion engine experiences through its pistons, cylinders, and cylinder heads, for example. Further, the total thermal energy loss through the insulated pistons, cylinders, and cylinder heads as presently disclosed is less than 5% of the total available chemical energy. In some implementations, this reduction in thermal energy loss reduces or eliminates the need for a liquid cooling system or an oil-cooler for the insulated internal combustion engine. In one implementation, the average thermal energy loss for an insulated combustion chamber is 100 W/m² with an average 3000 K temperature gradient between the combustion chamber and the exterior of insulated components of the insulated internal combustion engine.

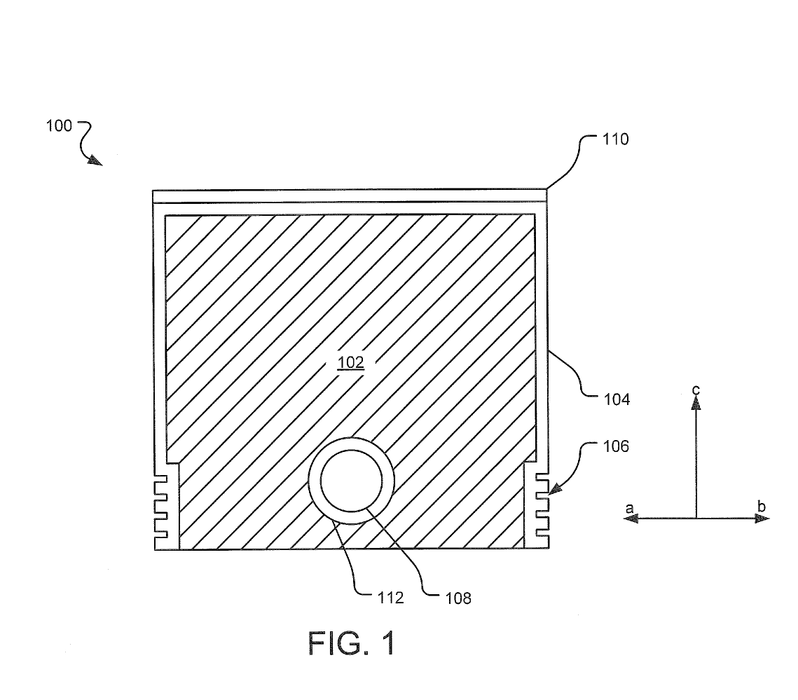

FIG. 1 is an example insulative piston 100 for a reciprocating internal combustion engine (not shown). The piston 100 is configured to be reciprocated within a cylinder (not shown) to produce power in an internal combustion engine (not shown), as described herein. The piston 100 includes a mass of high-porosity insulative material 102 (e.g., carbon foam, high-porosity silicon carbide foam) surrounded by a low-porosity sealing structure 104 (e.g., carbon fibre-reinforced carbon, pyrolytic graphite, low porosity silicon carbide, various refractory metals, tantalum, niobium, tungsten, rhenium, molybdenum, cordierite, and alumina zirconium oxide). The piston 100 may also include a low-reactivity coating 110 (e.g., oxidation resistant refractory metals, iridium or iridium/rhenium eutectic mixtures, hafnium carbide, metal oxide chemical vapors, and/or silicon carbide. The coating 110 may also include two or more layers of one or more of the aforementioned materials. Other materials may be used for the insulative material 102, the sealing structure 104, and/or the coating 110 that possess the structural, insulative, permeability, and reactivity properties desired for the insulative material 102, the sealing structure 104, and/or the coating 110.

The sealing structure 104 includes one or more grooves (e.g., groove 106) configured to receive piston rings that provide compression sealing and/or oil control within an interface between the piston 100 and the cylinder. The grooves may be located away from the combustion chamber to prevent damage to the piston rings caused by the intense heat within the combustion chamber. Further, if the piston 100 does not experience significant thermal expansion in the a-b plane over the expected temperature range, the piston 100 may not require piston rings. Thus, the piston 100 may not have grooves for piston rings, but rather ride on a thin gas boundary layer. Further, the piston 100 includes a bore 108 through the insulative material 102 adapted to receive a connecting rod (not shown) that attaches to a corresponding crankshaft (not shown). The crankshaft converts reciprocating linear motion of the piston 100 into rotational motion of the crankshaft. The bore 108 may also include a reinforcing or bearing ring 112 to reduce wear on the insulative material 102.

The piston 100 may experience a large temperature drop over its length from the combustion chamber to the bottom of the piston 100. In some implementations, the piston 100 may include a draft angle (not shown). The draft angle may be between 1 and 2 degrees, for example, in order to compensate for thermal expansion of the top of the piston 100 as compared to the bottom of the piston 100 of a fully insulated, long thermal assembly. The draft angle will help prevent the piston 100 from seizing within the cylinder due to thermal expansion of the significantly hotter top of the piston 100 relative to the bottom of the piston 100. The piston 100 may also include a domed top (not shown) to vary the compression ratio of the combustion chamber.

The insulative material 102 is a material that is highly insulative and able to survive high operating temperatures (e.g., higher than 1500° C.) without degradation. In other implementations, the insulative material 102 is a material that is highly insulative and able to survive even higher operating temperatures (e.g., higher than 2000° C. or 2200° C.) without degradation. In some high performance fuel/oxidizer applications, these temperatures may be higher than 2500° C. The high temperatures are illustrative of the operating temperature of an internal combustion engine utilizing the presently disclosed technology. Further, the insulative material 102 is also able to withstand large temperature swings (e.g., −40° C. to 2200° C.). The large temperature swings are indicative of an internal combustion engine at rest in a very cold ambient temperature environment, being brought up to operating temperature during operation, and then being brought back to rest in the cold ambient environment. The insulative material 102 may be exposed to these temperature variations rapidly and at many times during the life of the internal combustion engine. The temperatures specified herein are examples only and not intended to limit the presently disclosed technology.

In implementations where the insulative material 102 is carbon foam, the carbon foam contains an array of pores to aid in thermal insulation. While evacuated space is typically very insulating, at very high temperatures the pores can transmit significant radiative heat through the carbon foam. To remedy this, the pores may be filled with a carbon aerogel for additional thermal resistance to the radiative heat transfer through the carbon foam. The carbon aerogel is highly insulative to conductive, convective, and radiative heat transfer. In one implementation, the carbon aerogel may be deposited via chemical vapor deposition.

In some implementations, the fuel, oxidizer, and/or products of combustion of the fuel and oxidizer may be able to permeate the insulative material 102 without a structure separating the fuel, oxidizer, and/or products of their combustion from the insulative material 102. Permeation of the fuel, oxidizer, and/or products of their combustion into the insulative material 102 may reduce its insulative properties and/or reduce the temperature resistance and/or structural strength of the insulative material 102. As a result, the sealing structure 104 seals the insulative material 102 from the contaminants from the combustion chamber and is able to survive the aforementioned high operating temperatures and large temperature swings without degradation.

The sealing structure 104 may include a combination of a binder or high temperature paste that can fill and seal out pores of the insulative material 102 combined with a composite fabric that can be applied to the exterior of the insulative material 102. The sealing structure 104 may have a coefficient of thermal expansion similar to the insulative material 102 so that cracking and other structure failures between the interface of the sealing structure 104 and the insulative material 102 caused by temperature changes may be prevented.

The sealing structure 104 may also have anisotropic thermal properties such as thermal conductivity. The sealing structure 104 may be oriented so that it's lowest thermal conductivity direction is parallel to the length of the piston 100 (i.e., in the c-direction). As a result, the sealing structure 104 can aid in the insulative properties of the piston 100. Further, thermal energy may transfer from the combustion chamber downward (i.e., in the negative c-direction) through the sealing structure 104 along the piston 100 walls. As a result, the thickness of the sealing structure 104 may be reduced to a minimum necessary to seal the outer pores of the insulative material and provide the smallest thermal path through the sealing structure 104 along the piston 100 walls.

In one implementation, the sealing structure 104 may be constructed of pyrolitic graphite. Pyrolitic graphite typically has a low gas permeability and a thermal conductivity of approximately 300 W/mK in the a-b plane, but only approximately 1 to 4 W/mK in the c-direction. Even though the thermal conductivity in the c-direction is relatively low compared to the thermal conductivity in the a-b plane, 1 to 4 W/mK is a high thermal conductivity relative to the needs of an internal combustion engine in accordance with the presently disclosed technology. Accordingly, the thickness of the piston 100 walls may be minimized to present the smallest cross-sectional area normal to the heat flow while still being able to withstand the combustion pressures of an internal combustion engine. The relatively high thermal conductivity in the a-b plane allows heat to readily flow in the a-b plane, but this heat flow is contained in close proximity to the combustion zone using insulative material 102.

Refractory metals (e.g., niobium and tantalum) or carbides (e.g., silicon carbide) possessing sufficient structure, thermal, and/or permeability properties may also be used to construct the sealing structure 104 and/or insulative material 102. For example, a stack of refractory metal layers separated by low cross-sectional area posts may be used to insulate against radiative, convective, and/or conductive heat transfer. While refractory metals are typically less brittle than pyrolytic graphite, refractory metals also typically have higher thermal conductivity than graphite (at least in the c-direction). As a result, very thin layers of the refractory metals (e.g., one or more layers of 1-2 thousandths of an inch) may be used to reduce thermal conductivity of a refractory metal sealing structure 104.

In some implementations, the sealing structure 104 is reactive with the fuel, oxidizer, and/or products of combustion of the fuel and oxidizer. For example, the sealing structure 104 may oxidize in the presence of oxygen. The low-reactivity coating 110 coats surfaces of the sealing structure 104 exposed to the combustion chamber. These surfaces may include only a top of the piston 100 (as depicted in FIG. 1) or the top and sides of the piston 100. The coating 110 prevents the sealing structure 104 from degrading due to reactions with the fuel, oxidizer, and/or products of combustion of the fuel and oxidizer.

The relatively high speed and of the piston 100, its rapid changes of direction of motion during reciprocation, and the explosive and compressive forces within the combustion chamber combine for significant compressive and tensile forces on the piston 100. In one implementation, the piston 100 is designed to operate under 2,000 psia compressive stress and 500 psia tensile stress at peak RPM of the internal combustion engine with a 2.0 safety factor. The high-porosity insulative material 104 and the low-porosity sealing structure 104 in combination is able to withstand the repeated compressive, tensile, and explosive forces applied on the piston 100 as it reciprocates within the internal combustion engine.

In one implementation, insulative material 102 provides the majority of the structural resistance to the compressive and tensile forces on the piston 100, while the sealing structure 104 merely seals the insulative material 102 from contaminants from the combustion chamber. For example, a high-strength carbon foam may be used. In another implementation, the sealing structure 104 provides the majority of the structural resistance to the compressive and tensile forces on the piston 100, while the insulative material 102 merely provides the insulative properties of the piston 100. In still other implementations, both the insulative material 102 and the sealing structure 104 both provide significant structural resistance to the compressive and tensile forces on the piston 100.

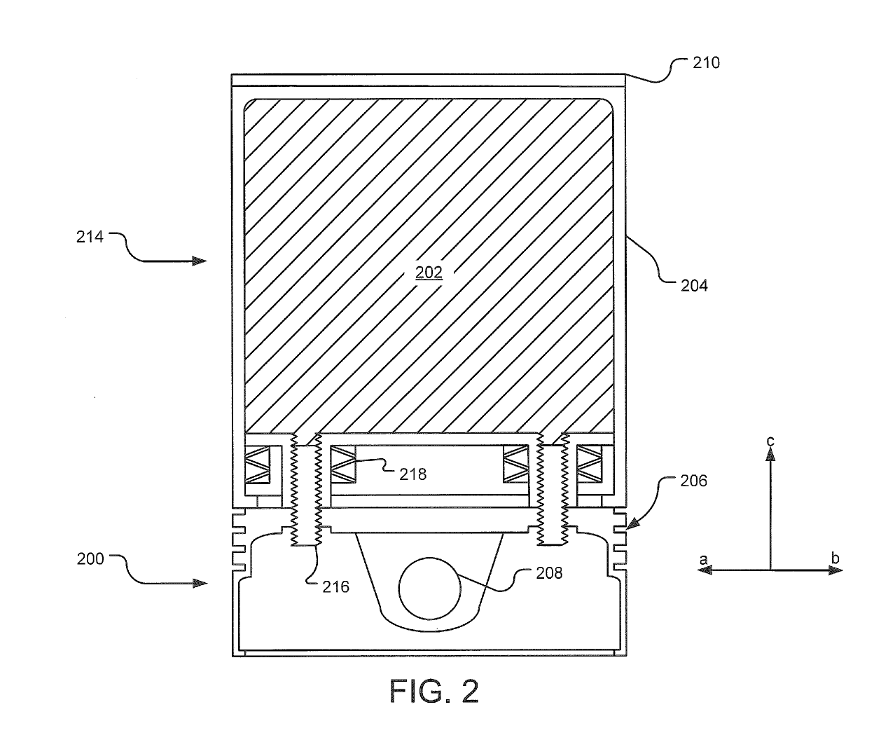

FIG. 2 is an example insulative piston cap 214 on a piston 200 for a reciprocating internal combustion engine (not shown). The piston cap 214 is cylindrical and fits into a cylinder (not shown) in a manner similar to a conventional piston. Insulative piston cap 214 includes fasteners (e.g., fastener 216) for attaching the insulative piston cap 214 to the piston 200. The piston cap 214 includes a mass of high-porosity insulative material 202 (e.g., carbon foam, high-porosity silicon carbide foam) surrounded by a low-porosity sealing structure 204 (e.g., carbon fibre-reinforced carbon, pyrolytic graphite, low porosity silicon carbide, various refractory metals, tantalum, niobium, tungsten, rhenium, molybdenum, cordierite, and alumina zirconium oxide). The piston cap 214 may also include a low-reactivity coating 210 (e.g., oxidation resistant refractory metals, iridium or iridium/rhenium eutectic mixtures, hafnium carbide, metal oxide chemical vapors, and/or silicon carbide. The coating 110 may also include two or more layers of one or more of the aforementioned materials. Other materials may be used for the insulative material 202, the sealing structure 204, and/or the coating 210 that possess the structural, insulative, permeability, and reactivity properties desired for the insulative material 202, the sealing structure 204, and/or the coating 210. The high-porosity insulative material 202 and the low-porosity sealing structure 204 are configurable to withstand the temperatures and pressures of combustion, while providing a highly thermally resistive paths away from the combustion chambers of the internal combustion engine.

The piston 200 includes one or more grooves (e.g., groove 206) configured to receive piston rings that provide compression sealing and/or oil control within an interface between the piston 200 and the cylinder. If the piston 200 does not experience significant thermal expansion in the a-b plane over the expected temperature range, the piston 200 may not require piston rings. Thus, the piston 100 may not have grooves for piston rings, but rather ride on a thin gas boundary layer. Further, the piston 200 includes a bore 208 through the piston 200 adapted to receive a connecting rod (not shown) that attaches to a corresponding crankshaft (not shown). The crankshaft converts reciprocating linear motion of the piston 200 into rotational motion of the crankshaft.

The piston 200 and/or piston cap 214 will experience a large temperature drop over their length from the combustion chamber to the bottom of the piston 200. In some implementations, the piston 200 and piston cap 214 may include a draft angle (not shown). The draft angle may be between 1 and 2 degrees, for example, in order to compensate for thermal expansion of the top of the piston cap 214 as compared to the bottom of the piston 200. The draft angle will help prevent the piston 200 and/or piston cap 214 from seizing within the cylinder due to thermal expansion of the significantly hotter top of the piston cap 214 relative to the bottom of the piston 100. The piston cap 214 may also include a domed top (not shown) to vary the compression ratio of the combustion chamber.

In one implementation, the piston cap 214 is attached to the top of the piston 200 and functions as a crank case thermal shield, which keeps the heat of combustion in the combustion zone and away from the crank case lubricants. The piston cap 214 may be compressed against the piston 200 with one or more Belleville washers or other springs (e.g., washer 218) there between. During thermal expansion of the piston cap 214, differences in thermal expansion between the sealing structure 204 and the insulative material 202 is accommodated by the spring washer 218. Gap losses are mitigated by combusted gasses that will reside in a gap around the piston cap 214, between the piston cap 214 and the cylinder. Further, these combusted gases resist un-combusted gasses from occupying the gap.

The insulative material 202 is a material that is highly insulative and able to survive the aforementioned high operating temperatures and large temperature swings without degradation. The temperatures specified herein are examples only and not intended to limit the presently disclosed technology. In implementations where the insulative material 202 is carbon foam, the carbon foam contains an array of pores to aid in thermal insulation. While evacuated space is typically very insulating, at very high temperatures the pores can transmit significant radiative heat through the carbon foam. To remedy this, the pores may be filled with a carbon aerogel for additional thermal resistance to the radiative heat transfer through the carbon foam. The carbon aerogel is highly insulative to conductive, convective, and radiative heat transfer. In one implementation, the carbon aerogel may be deposited via chemical vapor deposition.

In some implementations, the fuel, oxidizer, and/or products of combustion of the fuel and oxidizer may be able to permeate the insulative material 202 without a structure separating the fuel, oxidizer, and/or products of their combustion from the insulative material 202. Permeation of the fuel, oxidizer, and/or products of their combustion into the insulative material 202 may reduce its insulative properties and/or reduce the temperature resistance and/or structural strength of the insulative material 202. As a result, the sealing structure 204 seals the insulative material 202 from the contaminants from the combustion chamber and is able to survive the aforementioned high operating temperatures and large temperature swings without degradation.

The sealing structure 204 may include a combination of a binder or high temperature paste that can fill and seal out pores of the insulative material 202 combined with a composite fabric that can be applied to the exterior of the insulative material 202. The sealing structure 204 may have a coefficient of thermal expansion similar to the insulative material 202 so that cracking and other structure failures between the interface of the sealing structure 204 and the insulative material 202 caused by temperature changes may be prevented.

The sealing structure 204 may also have anisotropic thermal properties such as thermal conductivity. The sealing structure 204 may be oriented so that it's lowest thermal conductivity direction is parallel to the length of the piston cap 214 (i.e., in the c-direction). As a result, the sealing structure 204 can aid in the insulative properties of the piston 200. Further, thermal energy may transfer from the combustion chamber downward (i.e., in the negative c-direction) through the sealing structure 204 along the piston cap 214 walls. As a result, the thickness of the sealing structure 204 may be reduced to a minimum necessary to seal the outer pores of the insulative material and provide the smallest thermal path through the sealing structure 204 along the piston cap 214 walls.

In one implementation, the sealing structure 204 may be constructed of pyrolitic graphite. Pyrolitic graphite typically has a low gas permeability and a thermal conductivity of approximately 300 W/mK in the a-b plane, but only approximately 1 to 4 W/mK in the c-direction. Even though the thermal conductivity in the c-direction is relatively low compared to the thermal conductivity in the a-b plane, 1 to 4 W/mK is a high thermal conductivity relative to the needs of an internal combustion engine in accordance with the presently disclosed technology. Accordingly, the thickness of the piston cap 214 walls may be minimized to present the smallest cross-sectional area normal to the heat flow while still being able to withstand the combustion pressures of an internal combustion engine. The relatively high thermal conductivity in the a-b plane allows heat to readily flow in the a-b plane, but this heat flow is contained in close proximity to the combustion zone using insulative material 202.

Refractory metals (e.g., niobium and tantalum) or carbides (e.g., silicon carbide) possessing sufficient structure, thermal, and/or permeability properties may also be used to construct the sealing structure 204 and/or insulative material 202. For example, a stack of refractory metal layers separated by low cross-sectional area posts may be used to insulate against radiative, convective, and/or conductive heat transfer. While refractory metals are typically less brittle than pyrolytic graphite, refractory metals also typically have higher thermal conductivity than graphite (at least in the c-direction). As a result, very thin layers of the refractory metals (e.g., one or more layers of 1-2 thousandths of an inch) may be used to reduce thermal conductivity of a refractory metal sealing structure 204.

In some implementations, the sealing structure 204 is reactive with the fuel, oxidizer, and/or products of combustion of the fuel and oxidizer. For example, the sealing structure 204 may oxidize in the presence of oxygen. The low-reactivity coating 210 coats surfaces of the sealing structure 204 exposed to the combustion chamber. These surfaces may include only a top of the piston cap 214 (as depicted in FIG. 1) or the top and sides of the piston cap 214. The coating 210 prevents the sealing structure 204 from degrading due to reactions with the fuel, oxidizer, and/or products of combustion of the fuel and oxidizer.

The relatively high speed and of the piston 200 and piston cap 214, its rapid changes of direction of motion during reciprocation, and the explosive and compressive forces within the combustion chamber combine for significant compressive and tensile forces on the piston 200 and piston cap 214, as discussed in detail above. The high-porosity insulative material 204 and the low-porosity sealing structure 204 in combination is able to withstand the repeated compressive, tensile, and explosive forces applied on the piston cap 214 as it reciprocates within the internal combustion engine.

In one implementation, insulative material 202 provides the majority of the structural resistance to the compressive and tensile forces on the piston cap 214, while the sealing structure 204 merely seals the insulative material 202 from contaminants from the combustion chamber. For example, a high-strength carbon foam may be used. In another implementation, the sealing structure 204 provides the majority of the structural resistance to the compressive and tensile forces on the piston cap 214, while the insulative material 202 merely provides the insulative properties of the piston cap 214. In still other implementations, both the insulative material 202 and the sealing structure 204 both provide significant structural resistance to the compressive and tensile forces on the piston cap 214.

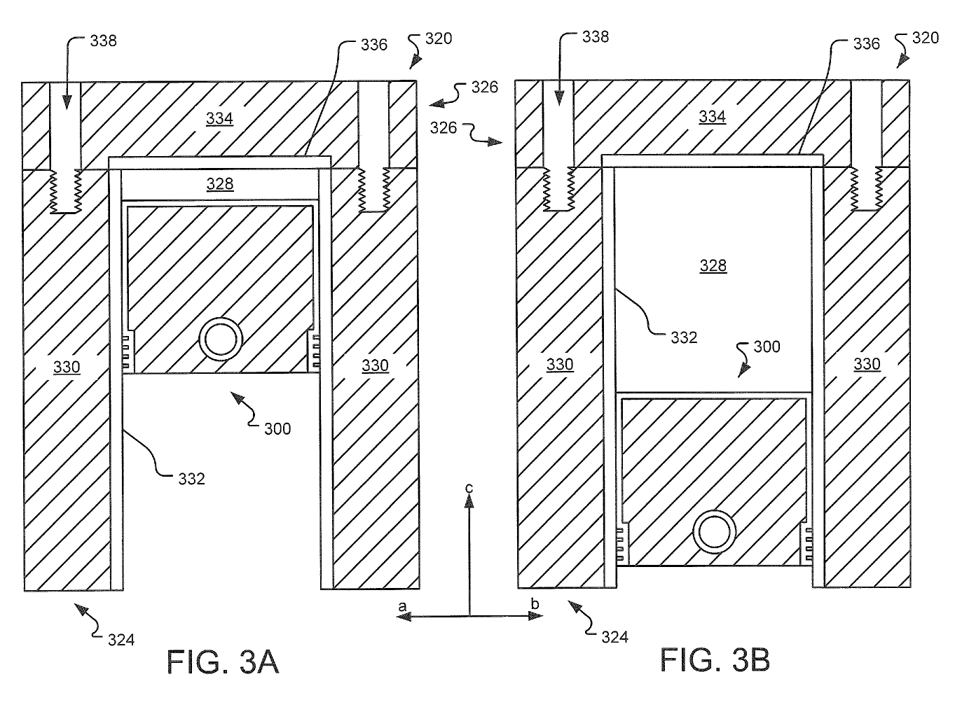

FIG. 3A is an example insulative piston assembly 320 in a top-dead center orientation. The piston assembly 320 includes an insulative piston 300, an insulative cylinder 324, and an insulative cylinder head 326. The insulative piston 300, which forms a bottom of an associated combustion chamber 328, is configured to reciprocate in the c-direction within the insulative cylinder 324, which forms sides of the combustion chamber 328. In FIG. 3A, the insulative piston 300 depicted at top-dead center within the insulative cylinder 324, which means that the insulative piston 300 has moved as far in the positive c-direction as it is permitted to go and the combustion chamber 328 is as small as it is permitted to be. In 4-stroke engines, top-dead center orientation corresponds to the end of a compression stroke and an exhaust stroke. The insulative cylinder head 326 may include valves, ports, fuel injection, and/or ignition systems for the combustion chamber 328, for example, and forms the top of the combustion chamber 328.

Similar to the way the insulative piston 300 provides thermal resistance to heat flow from the combustion chamber 328 propagating in the negative c-direction (not shown), the insulative cylinder 324 primarily provides thermal resistance in the a-b plane and the insulative cylinder head 326 primarily provides thermal resistance in the positive c-direction. However, both the insulative cylinder 324 and the insulative cylinder head 326 also minimize heat flow in their corollary directions (i.e., c-direction for the insulative cylinder 324, and in the a-b plane for the insulative cylinder head 326). Various applications of internal combustion engines may utilize one or more of the insulative piston 300, the insulative cylinder 324, and the insulative cylinder head 326. In an implementation utilizing all of insulative piston 300, the insulative cylinder 324, and the insulative cylinder head 326, the combustion chamber 328 is insulated in all directions, allowing the combustion chamber 328 to reach very high operating temperatures as discussed herein.

The insulated piston 300 has structural, thermal, permeability, and reactivity properties as described above with regard to FIGS. 1 and 2. The insulative cylinder 324 includes a cylindrical sleeve of a low-porosity sealing structure 332 surrounded on its sides by a mass of high-porosity insulative material 330. The insulative cylinder 324 may also include a low-reactivity coating on the interior of the cylindrical sleeve of the low-porosity sealing structure 332 (not shown).

The insulative material 330, sealing structure 332, and the coating of the insulative cylinder 324 may have similar structural, thermal, permeability, and reactivity properties as described above with regard to the insulative material 102, 202, sealing structure 104, 204, and coating 110, 210 of the piston 100 and piston cap 214 depicted in FIGS. 1 and 2.

The insulative cylinder head 326 includes a mass of high-porosity insulative material 334 and a low-porosity sealing structure 336 adjacent the combustion chamber 328. The insulative cylinder head 326 may also include a low-reactivity coating (not shown) on the interior of the sealing structure 336 immediately adjacent the combustion chamber 328. The insulative material 334, sealing structure 336, and the coating of the insulative cylinder head 326 may have similar structural, thermal, permeability, and reactivity properties as described above with regard to the insulative material 102, 202, sealing structure 104, 204, and coating 110, 210 of the piston 100 and piston cap 214 depicted in FIGS. 1 and 2.

Materials such as pyrolytic graphite used in the sealing structures 332, 336 may have low tensile strength and much higher compressive strength. In some implementations, these materials may be precompressed with structures like bolts to ensure that the maximum tensile stresses produced in the piston assembly 320 during combustion are lower than the maximum allowable tensile stress of the material used in the sealing structures 332, 336 of the piston assembly 320.

The cylinder head 326 may be attached to the cylinder 324 using bolt holes (e.g., bolt hole 338) through the cylinder head 326 and threaded bolt holes in the cylinder 324. Interfaces between the cylinder 324 and the cylinder head 326 may have a gasket (not shown) between. The gasket may be designed to survive the high operating temperature condition of the combustion chamber 328. One such example gasket is precompressed (e.g., at 4,000 psia) pyrolytic carbon cap insulation. In another implementation, a lower temperature gasket could be used that is locally cooled with minimal overall heat loss due to the relatively low surface area of the gasket meeting the combustion chamber 328. Other ways of securely attaching the cylinder head 326 to the cylinder 324 are contemplated herein.

FIG. 3B is the example insulative piston assembly 320 of FIG. 3A in a bottom-dead center orientation. The piston assembly 320 includes an insulative piston 300, an insulative cylinder 324, and an insulative cylinder head 326. The insulative piston 300, which forms a bottom of an associated combustion chamber 328, is configured to reciprocate in the c-direction within the insulative cylinder 324, which forms sides of the combustion chamber 328. In FIG. 3B, the insulative piston 300 depicted at bottom-dead center within the insulative cylinder 324, which means that the insulative piston 300 has moved as far in the negative c-direction as it is permitted to go and the combustion chamber 328 is as large as it is permitted to be. In 4-stroke engines, bottom-dead center orientation corresponds to the end of an intake stroke and a power stroke. The insulative cylinder head 326 may include valves, ports, fuel injection, and/or ignition systems for the combustion chamber 328, for example, and forms the top of the combustion chamber 328.

The insulative cylinder 324 and insulative cylinder head 326 are designed to handle structural stresses that are imparted on them. Unlike the insulated piston 300, these static structures endure stresses that are primarily associated with gas pressure in the combustion chamber 328. Structural loads can be accommodated by the sealing structures 332, 336; by high strength insulating materials used for 334, 330; and/or a combination of the two. Since the gas pressure is highest at top-dead-center and typically drops quickly as the piston 300 moves in the negative c-direction, the cylinder wall 332 can be designed to have additional structure near the top-dead-center orientation.

The insulated piston 300 has structural, thermal, permeability, and reactivity properties as described above with regard to FIGS. 1 and 2. The insulative cylinder 324 includes a cylindrical sleeve of a low-porosity sealing structure 332 surrounded on its sides by a mass of high-porosity insulative material 330. The insulative cylinder 324 may also include a low-reactivity coating on the interior of the cylindrical sleeve of the low-porosity sealing structure 332 (not shown).

The insulative material 330, sealing structure 332, and the coating of the insulative cylinder 324 may have similar structural, thermal, permeability, and reactivity properties as described above with regard to the insulative material 102, 202, sealing structure 104, 204, and coating 110, 210 of the piston 100 and piston cap 214 depicted in FIGS. 1 and 2. Further, since cylinder pressure rapidly decreases as the piston 300 expands toward bottom-dead center, the structural portion of the insulative cylinder 324 may become thinner in the negative c-direction. Reducing the thickness of the sealing structure 332 may further reduce the thermal transfer in the negative c-direction of heat from the combustion chamber 328 past the cylinder 324 by reducing the cross-section area available for the heat to flow.

The insulative cylinder head 326 includes a mass of high-porosity insulative material 334 and a low-porosity sealing structure 336 adjacent the combustion chamber 328. The insulative cylinder head 326 may also include a low-reactivity coating (not shown) on the interior of the sealing structure 336 immediately adjacent the combustion chamber 328. The insulative material 334, sealing structure 336, and the coating of the insulative cylinder head 326 may have similar structural, thermal, permeability, and reactivity properties as described above with regard to the insulative material 102, 202, sealing structure 104, 204, and coating 110, 210 of the piston 100 and piston cap 214 depicted in FIGS. 1 and 2.

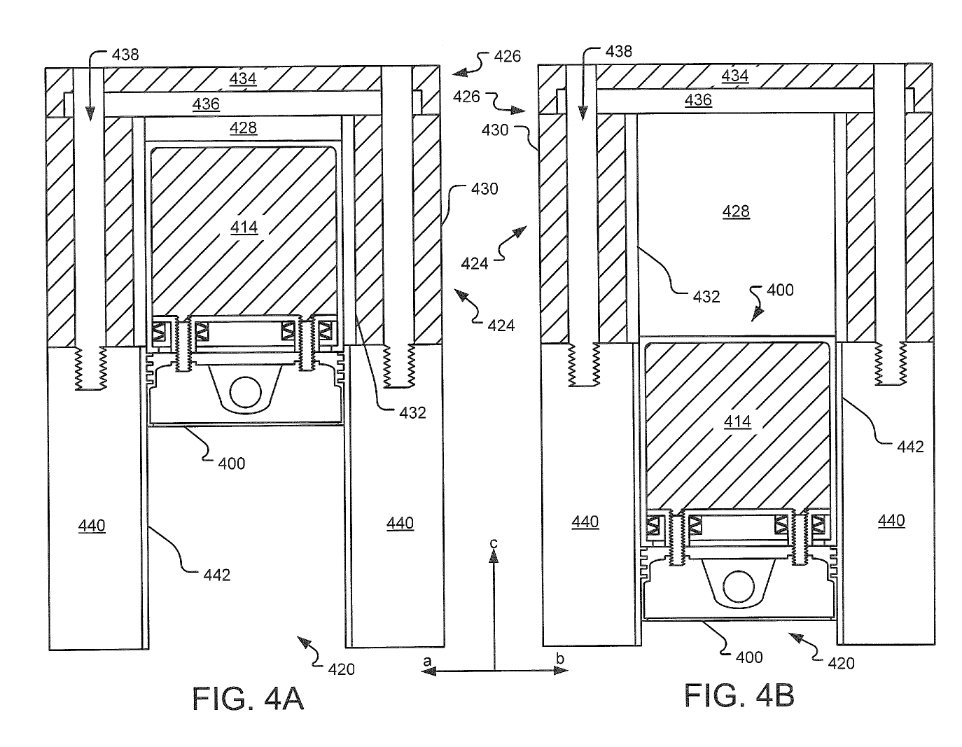

FIG. 4A is another example insulative piston assembly 420 in a top-dead center orientation. The piston assembly 420 includes a conventional piston 400 with an insulative piston cap 414, an insulative upper cylinder 424, a conventional lower cylinder 440, and an insulative cylinder head 426. The insulative piston cap 414, which forms a bottom of an associated combustion chamber 428, is configured to reciprocate along with the piston 400 in the c-direction within the insulative cylinder 424, which forms sides of the combustion chamber 428. The piston 400 further reciprocates within the lower cylinder 440, which may be equipped with a conventional cylinder liner 442 for wear resistance and sealing purposes.

In FIG. 4A, the piston 400 is depicted at top-dead center within the insulative cylinder 424, which means that the piston 400 has moved as far in the positive c-direction as it is permitted to go and the combustion chamber 428 is as small as it is permitted to be. In 4-stroke engines, top-dead center orientation corresponds to the end of a compression stroke and an exhaust stroke. The insulative cylinder head 426 may include valves, ports, fuel injection, and/or ignition systems for the combustion chamber 428, for example, and forms the top of the combustion chamber 428.

Similar to the way the insulative piston cap 414 provides thermal resistance to heat flow from the combustion chamber 428 from propagating in the negative c-direction (not shown), the insulative cylinder 424 primarily provides thermal resistance in the a-b plane and the insulative cylinder head 426 primarily provides thermal resistance in the positive c-direction. However, both the insulative cylinder 324 and the insulative cylinder head 326 also minimize heat flow in their corollary directions (i.e., c-direction for the insulative cylinder 324, and in the a-b plane for the insulative cylinder head 326). Various applications of internal combustion engines may utilize one or more of the insulative piston cap 414, the insulative cylinder 424, and the insulative cylinder head 426. In an implementation utilizing all of insulative piston cap 414, the insulative cylinder 424, and the insulative cylinder head 426, the combustion chamber 428 is insulated in all directions, allowing the combustion chamber 428 to reach very high operating temperatures as discussed herein.

The insulated piston cap 414 has structural, thermal, permeability, and reactivity properties as described above with regard to FIGS. 1 and 2. The insulative cylinder 424 includes a cylindrical sleeve of a low-porosity sealing structure 432 surrounded on its sides by a mass of high-porosity insulative material 430. The insulative cylinder 424 may also include a low-reactivity coating on the interior of the cylindrical sleeve of the low-porosity sealing structure 432 (not shown).

The insulative material 430, sealing structure 432, and the coating of the insulative cylinder 424 may have similar structural, thermal, permeability, and reactivity properties as described above with regard to the insulative material 102, 202, sealing structure 104, 204, and coating 110, 210 of the piston 100 and piston cap 214 depicted in FIGS. 1 and 2.

The insulative cylinder head 426 includes a mass of high-porosity insulative material 434 and a low-porosity sealing structure 436 adjacent the combustion chamber 428. The insulative cylinder head 426 may also include a low-reactivity coating (not shown) on the interior of the sealing structure 436 immediately adjacent the combustion chamber 428. The insulative material 434, sealing structure 436, and the coating of the insulative cylinder head 426 may have similar structural, thermal, permeability, and reactivity properties as described above with regard to the insulative material 102, 202, sealing structure 104, 204, and coating 110, 210 of the piston 100 and piston cap 214 depicted in FIGS. 1 and 2.

Materials such as pyrolytic graphite used in the sealing structures 432, 436 may have low tensile strength and much higher compressive strength. In some implementations, these materials may be precompressed with structures like bolts to ensure that the maximum tensile stresses produced in the piston assembly 420 during combustion are lower than the maximum allowable tensile stress of the material used in the sealing structures 432, 436 of the piston assembly 420.

The cylinder head 426 may be attached to the lower cylinder 440 using bolt holes (e.g., bolt hole 438) through the cylinder head 426 and the upper cylinder 424 and threaded bolt holes in the lower cylinder 440. In the implementation of FIGS. 4A and 4B, the bolt holes extend through the cylinder head sealing structure 436. This is in contrast to the implementation of FIGS. 3A and 3B, wherein the bolts holes do not extend through the cylinder head sealing structure 336. These implementations vary depending on whether the sealing structures 336, 436 or the insulating materials 334, 434 are the primary structural components of the cylinder heads 326, 426. Interfaces between the two or more of the lower cylinder 440, the upper cylinder 424, and the cylinder head 426 may have a gasket (not shown) between. The gasket may be designed to survive the high operating temperature condition of the combustion chamber 428. One such example gasket is precompressed (e.g., at 4,000 psia) pyrolytic carbon cap insulation. In another implementation, a lower temperature gasket could be used that is locally cooled with minimal overall heat loss due to the relatively low surface area of the gasket meeting the combustion chamber 428. Other ways of securely attaching the cylinder head 426 to the cylinder 424 are contemplated herein.

FIG. 4B is the example insulative piston assembly 420 of FIG. 4A in a bottom-dead center orientation. The piston assembly 420 includes a conventional piston 400 with an insulative piston cap 414, an insulative upper cylinder 424, a conventional lower cylinder 440, and an insulative cylinder head 426. The insulative piston cap 414, which forms a bottom of an associated combustion chamber 428, is configured to reciprocate along with the piston 400 in the c-direction within the insulative cylinder 424, which forms sides of the combustion chamber 428. The piston 400 further reciprocates within the lower cylinder 440, which may be equipped with a conventional cylinder liner 442 for wear resistance and sealing purposes.

In FIG. 4B, the piston 400 is depicted at bottom-dead center within the insulative cylinder 424, which means that the piston 400 has moved as far in the negative c-direction as it is permitted to go and the combustion chamber 428 is as large as it is permitted to be. In 4-stroke engines, top-dead center orientation corresponds to the end of an intake stroke and a power stroke. The insulative cylinder head 426 may include valves, ports, fuel injection, and/or ignition systems for the combustion chamber 428, for example, and forms the top of the combustion chamber 428.

The insulated piston cap 414 has structural, thermal, permeability, and reactivity properties as described above with regard to FIGS. 1 and 2. The insulative cylinder 424 includes a cylindrical sleeve of a low-porosity sealing structure 432 surrounded on its sides by a mass of high-porosity insulative material 430. The insulative cylinder 424 may also include a low-reactivity coating on the interior of the cylindrical sleeve of the low-porosity sealing structure 432 (not shown). Further, since cylinder pressure rapidly decreases as the piston 400 expands toward bottom-dead center, the structural portion of the insulative cylinder 424 may become thinner in the negative c-direction. Reducing the thickness of the sealing structure 432 may further reduce the thermal transfer in the negative c-direction of heat from the combustion chamber 428 past the cylinder 424 by reducing the cross-section area available for the heat to flow.

The insulative cylinder 424 and insulative cylinder head 426 are designed to handle structural stresses that are imparted on them. Unlike the insulated piston cap 414, these static structures endure stresses that are primarily associated with gas pressure in the combustion chamber 428. Structural loads can be accommodated by the sealing structures 432, 436; by high strength insulating materials used for 434, 430; and/or a combination of the two. Since the gas pressure is highest at top-dead-center and typically drops quickly as the piston cap 414 moves in the negative c-direction, the cylinder wall 432 can be designed to have additional structure near the top-dead-center orientation.

The insulative material 430, sealing structure 432, and the coating of the insulative cylinder 424 may have similar structural, thermal, permeability, and reactivity properties as described above with regard to the insulative material 102, 202, sealing structure 104, 204, and coating 110, 210 of the piston 100 and piston cap 214 depicted in FIGS. 1 and 2.

The insulative cylinder head 426 includes a mass of high-porosity insulative material 434 and a low-porosity sealing structure 436 adjacent the combustion chamber 428. The insulative cylinder head 426 may also include a low-reactivity coating (not shown) on the interior of the sealing structure 436 immediately adjacent the combustion chamber 428. The insulative material 434, sealing structure 436, and the coating of the insulative cylinder head 426 may have similar structural, thermal, permeability, and reactivity properties as described above with regard to the insulative material 102, 202, sealing structure 104, 204, and coating 110, 210 of the piston 100 and piston cap 214 depicted in FIGS. 1 and 2.

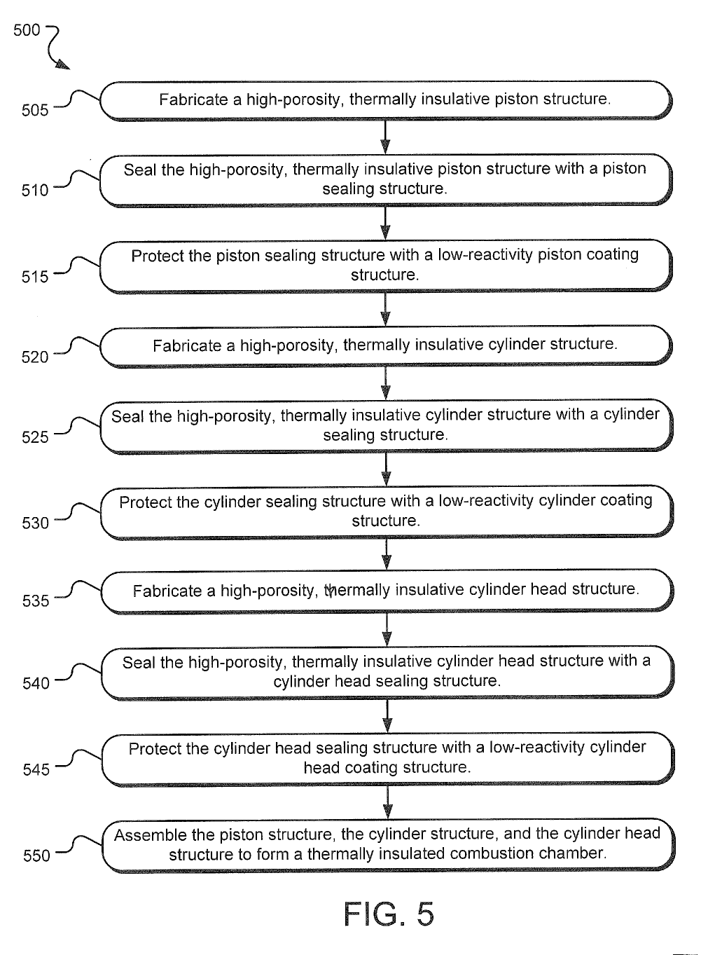

FIG. 5 illustrates example operations 500 for manufacturing an insulative piston assembly for a reciprocating internal combustion engine. A fabricating operation 505 fabricates a high-porosity, thermally insulative piston structure for the reciprocating internal combustion engine. The piston structure is capable of withstanding very high temperatures and wide temperature fluctuations and may also possess structural properties intended to allow the piston structure to withstand significant compressive and tensile forces. A sealing operation 510 seals the high-porosity, thermally insulative piston structure with a piston sealing structure. The piston sealing structure is also capable of withstanding very high temperatures and wide temperature fluctuations and is capable of sealing outer pores in the piston structure against contaminants. The piston sealing structure may also possess structural properties intended to allow the piston structure to withstand significant compressive and tensile forces. A protecting operation 515 protects the piston sealing structure with a low-reactivity piston coating structure. Since the piston sealing structure may be reactive with fuel, oxidizer, and/or products of combustion, the coating structure coats the piston sealing structure and prevents degradation of the piston sealing structure during operation of the reciprocating internal combustion engine. Degradation can include, for example, oxidation of the piston sealing structure or abrasion of the cylinder head sealing structure with contaminants in the combustion chamber of the reciprocating internal combustion engine.

In an alternative implementation, a high-strength, low porosity, sealing structure is first produced. This structure would then be surrounded by high-temperature insulating structure.

A fabricating operation 520 fabricates a high-porosity, thermally insulative cylinder structure for the reciprocating internal combustion engine. The cylinder structure is capable of withstanding very high temperatures and wide temperature fluctuations and may also possess structural properties intended to allow the cylinder structure to withstand significant compressive and tensile forces. A sealing operation 525 seals the high-porosity, thermally insulative cylinder structure with a cylinder sealing structure. The cylinder sealing structure is also capable of withstanding very high temperatures and wide temperature fluctuations and is capable of sealing outer pores in the cylinder structure against contaminants. The cylinder sealing structure may also possess structural properties intended to allow the cylinder structure to withstand significant compressive and tensile forces. A protecting operation 530 protects the cylinder sealing structure with a low-reactivity cylinder coating structure. Since the cylinder sealing structure may be reactive with fuel, oxidizer, and/or products of combustion, the coating structure coats the cylinder sealing structure and prevents degradation of the cylinder sealing structure during operation of the reciprocating internal combustion engine. Degradation can include, for example, oxidation of the cylinder sealing structure or abrasion of the cylinder head sealing structure with contaminants in the combustion chamber of the reciprocating internal combustion engine.

A fabricating operation 535 fabricates a high-porosity, thermally insulative cylinder head structure for the reciprocating internal combustion engine. The cylinder head structure is capable of withstanding very high temperatures and wide temperature fluctuations and may also possess structural properties intended to allow the cylinder head structure to withstand significant compressive and tensile forces. A sealing operation 540 seals the high-porosity, thermally insulative cylinder head structure with a cylinder head sealing structure. The cylinder head sealing structure is also capable of withstanding very high temperatures and wide temperature fluctuations and is capable of sealing outer pores in the cylinder head structure against contaminants. The cylinder head sealing structure may also possess structural properties intended to allow the cylinder head structure to withstand significant compressive and tensile forces. A protecting operation 545 protects the cylinder head sealing structure with a low-reactivity cylinder head coating structure. Since the cylinder head sealing structure may be reactive with fuel, oxidizer, and/or products of combustion, the coating structure coats the cylinder head sealing structure and prevents degradation of the cylinder head sealing structure during operation of the reciprocating internal combustion engine. Degradation can include, for example, oxidation of the cylinder head sealing structure or abrasion of the cylinder head sealing structure with contaminants in the combustion chamber of the reciprocating internal combustion engine.

An assembling operation 550 assembles the piston structure, the cylinder structure, and the cylinder head structure to form a fully insulated combustion chamber for the reciprocating internal combustion engine. The fully insulated combustion chamber is able to operate at temperatures significantly higher than standard internal combustion engines and is able to achieve much greater efficiencies than standard internal combustion engines because much less energy produced from combustion is lost as waste heat through the insulated piston structure, the insulated cylinder structure, and the insulated cylinder head structure.

While various implementations of the presently disclosed technology have been described above, it should be understood that the piston assembly and components may be constructed of different materials, or of homogenous materials, depending on the combustion temperatures and pressures of the application. Various implementations of the presently disclosed technology have been described above with a certain degree of particularity, or with reference to one or more individual embodiments, those skilled in the art could make numerous alterations to the disclosed embodiments without departing from the spirit or scope of the presently disclosed technology. It is intended that all matter contained in the above description or shown in the accompanying drawings shall be interpreted as illustrative only and not limiting. Changes in detail or structure may be made without departing from the basic elements of the presently disclosed technology.

What is claimed is:

1. A reciprocating internal combustion piston assembly comprising:
a high-porosity piston structure configured to thermally insulate an adjacent combustion chamber from lower operating temperature piston and engine components and withstand compressive and tensile forces exerted on the piston assembly during operation; and
a low-porosity piston sealing structure configured to seal the high-porosity piston structure from contaminants from the combustion chamber.

2. The reciprocating internal combustion piston assembly of claim 1, wherein the high-porosity piston structure includes a carbon foam.

3. The reciprocating internal combustion piston assembly of claim 2, wherein pores within the carbon foam are filled with a carbon aerogel.

4. The reciprocating internal combustion piston assembly of claim 1, wherein the high-porosity piston structure includes a silicon carbide foam.

5. The reciprocating internal combustion piston assembly of claim 1, wherein the low-porosity piston sealing structure includes a carbon-carbon composite.

6. The reciprocating internal combustion piston assembly of claim 1, further comprising:
a low-reactivity piston coating structure configured to seal the low-porosity piston sealing structure from degradation due to exposure to the combustion chamber.

7. The reciprocating internal combustion piston assembly of claim 6, wherein the low-reactivity piston coating structure includes one or more of iridium-rhenium, hafnium carbide, and silicon carbide.

8. The reciprocating internal combustion piston assembly of claim 6, wherein the degradation includes carbon oxidation.

9. The reciprocating internal combustion piston assembly of claim 1, further comprising:
a piston, wherein the high-porosity piston structure and the low-porosity piston sealing structure are oriented as a cap on the piston.

10. The reciprocating internal combustion piston assembly of claim 1, wherein the high-porosity piston structure and the low-porosity piston sealing structure together defines a piston in the reciprocating internal combustion piston assembly.

11. The reciprocating internal combustion piston assembly of claim 1, further comprising:
a high-porosity cylinder wall structure configured to thermally insulate an adjacent combustion chamber; and
a low-porosity cylinder sealing structure configured to seal the high-porosity cylinder wall structure from contaminants from the combustion chamber and withstand compressive and tensile forces exerted on the piston assembly during operation.

12. The reciprocating internal combustion piston assembly of claim 11, wherein a gap between the low-porosity piston sealing structure and the low-porosity cylinder sealing structure decreases with distance from the combustion chamber, when the reciprocating internal combustion piston assembly is at a uniform temperature.

13. The reciprocating internal combustion piston assembly of claim 12, wherein the gap between the low-porosity piston sealing structure and the low-porosity cylinder sealing structure is constant with distance from the combustion chamber, when the reciprocating internal combustion piston assembly is at an operating temperature distribution.

14. The reciprocating internal combustion piston assembly of claim 1, further comprising:
a high-porosity cylinder head structure configured to thermally insulate an adjacent combustion chamber and withstand compressive and tensile forces exerted on the piston assembly during operation; and
a low-porosity cylinder head sealing structure configured to seal the high-porosity cylinder head structure from contaminants from the combustion chamber.

15. The reciprocating internal combustion piston assembly of claim 1, wherein a surface of the high-porosity piston structure facing the combustion chamber is domed.

16. A method of manufacturing a reciprocating internal combustion engine comprising:
fabricating a high-porosity piston structure configured to thermally insulate an adjacent combustion chamber and withstand compressive and tensile forces exerted on the piston assembly during operation; and
sealing the high-porosity piston structure with a low-porosity piston sealing structure configured to seal the high-porosity piston structure from contaminants from the combustion chamber.

17. The method of claim 16, further comprising:
protecting the low-porosity piston sealing structure from degradation using a low-reactivity piston coating structure.

18. A reciprocating internal combustion engine with one or more thermally insulated combustion chambers capable of operating at temperatures greater than about ° 1500 C.

19. The reciprocating internal combustion engine of claim 18, wherein one or more of the thermally insulated combustion chambers are capable of operating at temperatures greater than about 2000° C.

20. The reciprocating internal combustion engine of claim 18, wherein one or more of the thermally insulated combustion chambers are capable of operating at temperatures greater than about 2200° C.

21. The reciprocating internal combustion engine of claim 18, wherein one or more of the thermally insulated combustion chambers are capable of operating at temperatures greater than about 2500° C.

22. A reciprocating internal combustion engine, comprising:
a high-porosity piston structure configured to thermally insulate an adjacent combustion chamber and withstand compressive and tensile forces exerted on the piston structure during operation;
a low-porosity piston sealing structure configured to seal the high-porosity piston structure from contaminants from the combustion chamber;
a high-porosity cylinder wall structure configured to thermally insulate the combustion chamber;
a low-porosity cylinder sealing structure configured to seal the high-porosity cylinder wall structure from contaminants from the combustion chamber and withstand compressive and tensile forces exerted on the cylinder wall structure during operation;
a high-porosity cylinder head structure configured to thermally insulate the combustion chamber and withstand compressive and tensile forces exerted on the cylinder head structure during operation; and
a low-porosity cylinder head sealing structure configured to seal the high-porosity cylinder head structure from contaminants from the combustion chamber, wherein the high-porosity piston structure, the high-porosity cylinder wall structure, and the high-porosity cylinder head structure are configured to define the combustion chamber.

23. A combustion chamber for a reciprocating internal combustion engine comprising:
a chamber wall having an insulating structure configured to thermally insulate the combustion chamber and withstand compressive and tensile forces exerted on the chamber wall during operation of the engine and a sealing structure configured to seal the insulating structure from contaminants from the combustion chamber.

24. The combustion chamber of claim 23, wherein the insulating structure includes a carbon foam.

25. The combustion chamber of claim 23, wherein the sealing structure includes a carbon-carbon composite.

26. The combustion chamber of claim 23, wherein the insulating structure is a high-porosity piston structure and the sealing structure is a low-porosity piston sealing structure.

27. The combustion chamber of claim 23, wherein the insulating structure is a high-porosity cylinder wall structure and the sealing structure is a low-porosity cylinder sealing structure.

28. The combustion chamber of claim 23, wherein the insulating structure is a high-porosity cylinder head structure and the sealing structure is a low-porosity cylinder head sealing structure.

29. A reciprocating internal combustion piston assembly comprising:
a high-porosity piston structure configured to thermally insulate an adjacent combustion chamber from lower operating temperature piston and engine components; and
a low-porosity piston sealing structure configured to seal the high-porosity piston structure from contaminants from the combustion chamber and withstand compressive and tensile forces exerted on the piston assembly during operation.
